(19) United States
(12) Patent Application Publication
(10) Pub. No.: US 2015/0358685 A1
(43) Pub. Date: Dec. 10, 2015

(54) System to Enhance Television Viewing by Merging Television and the Internet

(71) Applicant: Eric Adjesson, Alpharetta, GA (US)

(72) Inventor: Eric Adjesson, Alpharetta, GA (US)

(21) Appl. No.: 14/297,597

(22) Filed: Jun. 5, 2014

(51) Int. Cl. H04N 21/478; H04N 21/8545; H04N 21/643; H04N 21/4725; H04N 21/239; H04N 21/472; H04N 21/858; H04N 21/81

(52) U.S. Cl. CPC H04N 21/47815; H04N 21/858; H04N 21/8545; H04N 21/8133; H04N 21/4725; H04N 21/2393; H04N 21/47217; H04N 21/64322; H04N 21/47202

(57) ABSTRACT

Disclosed is a system comprising: a control unit including a software application for detecting programming being displayed on a television, the software application further providing a graphical user interface to enable a viewer to obtain information about a selected object of interest appearing in the programming being displayed by the television; an inquiry server in communication with the control unit, the inquiry server configured to receive a viewer inquiry about the selected object of interest, and retrieve information about the selected object of interest in response to the viewer inquiry; an information server in communication with the inquiry server.

### CROSS REFERENCE TO RELATED APPLICATION

The present application is related to Utility patent application entitled “System to Enhance Television Viewing by Merging Television and the Internet,” filed 7 May 2012 and assigned filing Ser. No. 13/466,099, incorporated herein by reference in its entirety.

### FIELD OF THE INVENTION

The present invention relates to television viewing systems and, more particularly, to a system to enhance television viewing by merging television and the Internet in such a way that the two are interactive with one another.

### BACKGROUND OF THE INVENTION

Currently, there are attempts by other corporations to merge television and the power of the Internet; these companies only managed to provide format that makes it easy to view content of the internet on television sets. However, these conventional systems do not allow a user the opportunity to view information about the entertainment being viewed.

### BRIEF SUMMARY OF THE INVENTION

In one aspect of the present invention, a system for enhancing television viewing comprises: a control unit including a software application for detecting programming being displayed on a television, the software application further providing a graphical user interface to enable a viewer to obtain information about a selected object of interest appearing in the programming being displayed by the television; an inquiry server in communication with the control unit, the inquiry server configured to receive a viewer inquiry about the selected object of interest, and retrieve information about the selected object of interest in response to the viewer inquiry; an information server in communication with the inquiry server, the information server having an Internet link to the selected object in the television display, the Internet link for enabling the inquiry server to obtain information related to the selected object of interest and provide the obtained information to the inquiry server; and a purchasing server configured to transmit a purchase request to an object provider, the purchasing server configured to receive said purchase inquiry from said inquiry server, and communicate with a viewer account for sending a purchase request confirmation to the viewer.

In another aspect of the present invention, an entertainment information system for enhancing television viewing comprises: a software application for identifying the title and the time track of entertainment displayed on the television; the software application including software written in one or more computer codes and stored on computer readable media in the entertainment information system, the software having code segments to display a graphical user interface on the television, the code segments for enabling a viewer to select an object of interest displayed on the television so as to request information via the Internet about the selected object of interest; an information server in communication with the software application, the information server configured to provide the requested information to the viewer based on the identification of the detected title and time track of the entertainment displayed on the television; an information server in communication with the inquiry server, the information server configured to provide to the inquiry server a link to a vendor of the selected object of interest in response to receiving the requested information; and a purchasing server configured to receive a viewer purchasing request from the information server and for distributing the viewer purchasing request to at least one provider for either purchase or fulfillment.

In still another aspect of the present invention, a video player application functioning to perform an action comprising the steps of: playing on a display screen an audio visual program from one of an open source video and a closed source video on a digital platform and apparatus, detecting the video title of the audio visual program, time tracking the audio visual program during viewing, and providing a graphical user interface on the viewing screen related to an Internet website that contains content related to the audio video program playing on the display screen.

The additional features and advantage of the disclosed invention is set forth in the detailed description which follows, and will be apparent to those skilled in the art from the description or recognized by practicing the invention as described, together with the claims and appended drawings.

### BRIEF DESCRIPTION OF THE DRAWING

The foregoing aspects, uses, and advantages of the present invention will be more fully appreciated as the same becomes better understood from the following detailed description of the present invention when viewed in conjunction with the accompanying FIGURE, in which:

FIG. 1 is a diagrammatical illustration of an entertainment information system, in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present specification discloses a system that provides a software application-based system that enables interaction between a television, or other entertainment component, and the Internet. The application-based system brings true entertainment, programming, and movies to homes with the application-based system. As described in greater detail below, the application-based system functions to provide viewers with the option to purchase items of interest that are featured in the programming and are also listed in a software application database.

The application-based system also provides an alternative option for a viewer to purchase similar items of interest if the item of interest in the programming is pricey or otherwise unavailable. If none of the items listed in the software application database are of interest to a viewer at the time, the viewer can view links provided in the application-based system for information purposes.

The disclosed application-based system provides an innovative shopping ground and unique information haven for users who are entertained by movies, television shows, documentaries and the news. The provided information resides in servers and other sites via an application specific to a particular source of entertainment. The type of information provided to a user is dependent on the inquiries of the end-user.

The system of the present invention provides an entertainment information system that provides end-users with specific information about objects that is present in a given motion picture (e.g., TV shows, movies, documentaries, commercials). The application-based system is thus not only a source of knowledge for the end users related to items of interest seen in the programming displayed on the television screen; the disclosed system also serves as a means of shopping for the items of interest, when available via the software application database.

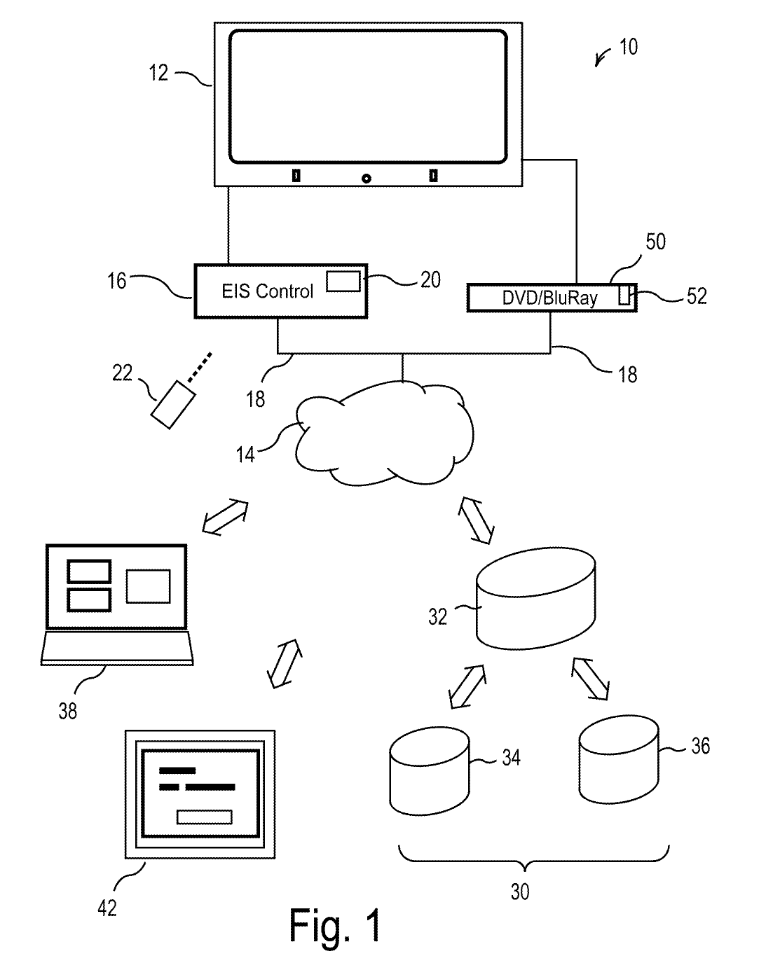

There is shown in FIG. 1 an entertainment information system (EIS) 10, in accordance with the present invention. The entertainment information system 10 enables interaction between an end-user and the visual acoustic base entertainment on many levels. The entertainment information system 10 may include a television set 12, or similar display device, where the television set 12 is configured to access various programming from the Internet 14, and provide selected programming to the user. The particular display apparatus can be any apparatus capable of video playback, storing and running an application. In an exemplary embodiment, a Smart television may be used to display the television show and to run software applications. An EIS control unit 16 received programming from the Internet 14 via a communication cable 18, conforming to USB or HDMI standards, for example. The EIS control unit 16 hosts an EIS software application 20 that enables the EIS control unit 16 to perform various operations.

The EIS control unit 16 may serve as a storage device having sufficient digital memory resources to store television programming, movies, documentaries, and commercials. The EIS control unit 16 may include a hard drive or an optical drive, similar to that found in a conventional digital video recorder (DVR). In an exemplary embodiment, the EIS control unit 16 may also have the capability to store PC-based games downloaded from a service provider.

Alternatively, the EIS control unit 16 may comprise a small electronic device suitable for connection to a DVR, or a gaming console. In an exemplary embodiment, the EIS control unit 16 may be directly connected to the television 12 via a USB, or an HOMI cable. The EIS control unit 16 may be a programmable commercial set top television box such as the VIA ARTIGO 1150 unit available from VIA Technologies. The user may use a remote control unit 22 to communicate with the EIS control unit 16 so as to interact with the entertainment information system 10.

It can be appreciated by one skilled in the art that the entertainment information system 10 enables the end user's television set 12 to become, essentially, an entertainment, shopping, and information center. The entertainment information system 10 thus satisfies a market that is currently being serviced through many different avenues. The entertainment information system 10 consolidates these avenues, and meets the entertainment needs of consumers through a multi-functional unit. A major aspect of the entertainment information system 10 is to serve as a single point of sale (POS) unit.

The EIS software application 20 may be hosted by the EIS control unit 16 and have the ability to detect shows and other programming that are being viewed or uploaded to the television 12. Detection of a particular program or show may be based on the programming title. The EIS control unit 16 functions to seamlessly pull the EIS software application 20 programmed for the particular entertainment. The EIS software application 20 remains in the background of the displayed programming until EIS software application 20 is needed by the end-user. When activated by an on-screen “Menu” button, for example, the EIS software application 20 may provide a menu or instructional text in the display screen of the television 12. A graphical user interface (GUI) may be provided on the screen to enable the end user to interact with the entertainment information system 10 and pull enquiries from a supporting system 30.

The supporting system 30 comprises three remote servers. An inquiry server 32 may be configured specifically to receive inquiries from the end user via the EIS software application 20 and the Internet 14. In response to an inquiry received from the inquiry server 32, the EIS software application 20 retrieves the information from either or both an information server 34 and a purchasing server 36. The EIS software application 20 may further function to retrieve requested information from a third-party websites 38.

The inquiry server 32 may store compounded information related to essentially any items or objects of interest in all available entertainment, programming, television channels, and television shows that the entertainment information system 10 supports. The inquiry server 32 includes information related to the location of the supported items and objects of interest, based on the items themselves. For example, music enquiries may be routed to websites such as, for example, Rhapsody or Amazon music. Or, book and video enquiries could be transmitted to Amazon.com and the history cable channels, for example.

The information server 34 is in communication with the inquiry server 32, and may store links to all items of interest that have been identified in the entertainment and shows on channels that the entertainment information system 10 supports. Preferably, this data is updated regularly for new programming and newly discovered items that the entertainment information system 10 will support. The information server 34 may also house enquiries that the entertainment information system 10 may not have been able to respond to with preselected vendors.

In such cases, administrative staff can follow up on the enquiry and retrieve relevant information through other vendors, and update the data in the information server 34 with new vendors and items of interest for future, similar enquiries. In an exemplary embodiment, the viewer has the ability to save Internet links a “save for later” folder, and may have the ability to share the contents of the “save for later” folder via social media.

In an exemplary embodiment, the information server 34 may be configured to store audio visual file titles, audio visual file time lines, links to independent websites with contents related to audio visual files supported by the entertainment information system 10, on all channels and audio visual delivery platforms. The information server 34 functions to provide, or feed, the database information to the EIS software application 20 and to a video player software application 52, described below.

The purchasing server 36 is in communication with the inquiry server 32, may receive all enquiries for information submitted by the end-users from the inquiry server 32, and may communicate with end user's accounts. The purchasing server 36 may send purchase enquiry confirmation to the end-user's account. In an exemplary embodiment, the purchasing server 36 may be the means by which end users of the entertainment information system 10 communicate with the administrative, or support staff at a call center 42, when necessary or appropriate. The final functionality of the purchasing server 36 is to track all inquiries, purchases, and traffic generated to a particular vendor's website.

Operating the entertainment information system 10, in accordance with the present invention, requires that the EIS control unit 16 is connected to the television 12, such as with a USB cable or an HDMI cable, for example. As explained above, the EIS software application 20 resident in the EIS control unit 16 functions to identify the title of a TV shows or movie being viewed on the screen of the television 12. Preferably, the time track of the show or movie is also identified by the EIS software application 20 at the same time.

The EIS control unit 16 may be linked to supporting system through: (i) an Internet provider via Ethernet cable or a wireless router, as known in the art, for example, and (ii) a network provider, such as dish or cable provider, through coaxial or HDMI cable. The EIS control unit 16 may download the appropriate application file for the entertainment being viewed to its hardware from the supporting system 30. The EIS software application 20 may operate from within the EIS control unit 16 and relay information between the GUI and the rest of the entertainment information system 10. If the end user is watching a DVD or a BluRay disc, the EIS software application 20 will be able to detect the movie title and provide similar services to the end user.

In an exemplary embodiment, the EIS software application 20 may access the programming or show metadata and pinpoint the title of show displayed on the television 12. Once the EIS software application 20 detects the title of the show, the EIS software application 20 will check the databases in the supporting system 30 to make sure the particular show is supported by the EIS software application 20. In an exemplary embodiment, the EIS software application 20 repeats this step at predetermined time intervals, such as once every three minutes, for example, to ensure that the show is still playing, or that the channel displayed on the television 12 has not been changed. If a particular show is not supported by the EIS software application 20, the EIS software application 20 may be rendered dormant.

If the EIS software application 20 supports the show, timeline tracking of the show may begin. Once the preceding steps have been executed, connection is established between the EIS software application 20, the EIS control unit 16, and the databases in the supporting system 30. If the particular show is supported, the viewer can make an enquiry or select an available item from the EIS software application 20 and the databases in the supporting system 30. In an exemplary embodiment, if the user activates a system menu and sees an item that is of interest, the item can be selected. The EIS software application 20 retrieves the link for that item from the server databases, The EIS software application 20 may then open a web browser on the television 12 to display the vender web link containing the information about the Item of interest.

Once an entertainment event has been detected and identified, the entertainment information system 10 may will preload the EIS software application 20 for that entertainment from the inquiry server 32. When the end user hears a song of interest, for example, he can pause the entertainment or programming, and press the menu button on his remote control unit 22. The EIS software application 20 generates the GUI for display on a convenient region of the screen of the television 12. The user is presented with an onscreen. preferably translucent, menu that will allow the user to navigate choices and make enquiries. For example, the user may navigate to a “current screen,” and then to an “object”.

The may also include a video player 50, such as a DVD player or a BluRay player, for providing programming or entertainment on the display screen of the television 12, The video player 50 may play both open source and closed source optical storage discs on any digital platform and apparatus. During the viewing process, the video player 50 may function to detect the video title and to time track the programming or entertainment during viewing by a user.

The video player software application 52 in the video player 50 serves to provide a GUI containing a list of independent websites that may contain content related to the programming being viewed on the television 12. The video player software application 52 also serves to receive graphical user interface content from the information server 34, makes Internet links available to viewers based on audio visual file (e.g., programming) running time, thus enabling the viewer to open the website links using a choice of browser. The video player software application 52 enables the viewer to select a video file (e.g., entertainment) from essentially any available video streaming service or website, whether the streaming source is open or closed. Further, the website links may be made available based on one or more preset time intervals, as a function of the audio visual time lines stored in the information server 34. It should be understood that, although the video player software application 52 has been downloaded into the video player 50 in the example provided, the video player software application 52 can readily be downloaded into any other apparatus that can be used to read a video file.

From the object selection, the user may select music, whereby all the music heard within each previous half-hour time segment of the movie or programming being viewed will be available for further enquiry. In the example provided, the user can select the song of interest using the remote control unit 22. In an exemplary embodiment, the EIS software application 20 may pull the song if interest by accessing the Rhapsody web application and by using a predetermined query for the song of interest.

The end user will have the opportunity to listen to the selected song and purchase it in a downloadable format such as an MP3 from a Rhapsody service. The song will be downloaded to a user account hosted on the purchasing server 36. If the user prefers to purchase an entire album instead of just a single musical selection, there may be provided an available link to the Amazon website where the user can purchase a “hard copy” of the respective album. The album may be sent to the address provided in the user's account. The same process may be applied to many similar consumer items such as: (i) apparel, (ii) vehicles, (iii) furniture, and (iv) accessories, where the manufacturer's webpage would be the primary source of information and purchases.

For items of interest that may not be found in the vendor webpage; prior research may be done by a support team and made available via the information server 34. If no suitable information is found, similar or alternative items may be made available to the user. Such alternative information may be gathered from the producers of supported shows, programming, and movies and loaded into the EIS software application 20. The entertainment information system 10 can provide supported category of items with links for the EIS software application 20 that will connect the respective items to the vendor's websites or to the information server 34. In the information server 34, the entertainment information system 10 may have resources available for items of interest that are not supported by vendor's web pages.

Television networks can provide advance lists of shows for research to be conducted for populating the entertainment information system 10 with the necessary links for the items of interest that will be supported. Information, such as “fact checking” of topics and claims being made, may have links to documented truths. News channels will have the option to populate the news channel application, or approve the information that is to be uploaded to the news channel system application because of the sensitive nature of the type of information and accuracy.

The entertainment information system 10 of the present invention clearly fulfills and exceeds end-users needs of interacting with their entertainment resources. The entertainment information system 10 provides the end-user the ability to: (i) select items of interest that are being viewed on the television 12, and (ii) pull any information desired about any supported items of interest on the said entertainment source. End users thus have the ability to experience objects through articles and other literature available at the time of request. The end-user may also experience the object or items through purchases, rentals, or a visit to a retail establishment, depending on the object in question. The entertainment information system 10 can serve as a web browsing tool or a gaming console, when not being used to watch television. In this configuration, a user may purchase online games, and the television 12 may serve as the console on which the games are played.

The present invention provides for at least three ways to access objects and information. In a first exemplary method, the user may “pause” the video entertainment when an object of interest is on the screen of the television 12, or, if the entertainment is primarily an audio program, when the sound of interest is heard. The end user will then be able to press the menu button on the remote control unit 22 or by using a wireless keyboard. This action will produce a GUI on the screen of the television 12, and the user can then select “current screen” on the GUI. The user can scroll to “objects,” and then “music.”

A listing or description of music that has been played, and/or is being played, will be made available on the display screen of the television 12. The user can then select from among the songs listed and play one or more sample selections. If the desired song is confirmed, the user can download or purchase a hard copy to be sent to an address. In the case of an object, after the entertainment is paused and the menu button has been pressed, the user can use the navigation key to highlight the different objects visible on the screen and select “enter” on the remote control unit 22 to initiate access to the object or song of interest.

In a second exemplary method, the user may gain access to objects of interest by pressing the “Menu” button. This action will open a selection menu on the screen of the television 12. A transparent or translucent GUI may be provided displaying a listing of objects of interest. One or more objects can then be selected from the listing for further information or for purchase. In a third exemplary method, the user may select a transparent ‘Menu’ button that appears at the end of the entertainment or programming selection. A GUI may then appear with a listing of objects of interest classified by type. One of more of the displayed objects will be available for selection, and may be identifiable by icon or thumb size picture.

In a first application example, an end-user has seen a dream vacation resort in a movie being viewed. The user quickly brings the topic to a companion's attention. The two viewers can then take action to purchase a vacation package to visit the famous area just viewed in the movie displayed on the television 12. With the use of the remote control unit 22, or by using a wireless key board, the viewers may select the onscreen menu button and navigate to “Current Scenery.”

The EIS software application 20 can then provide the users with general information related to the current scene location. In addition, other relevant information such as: climate, population, income level, locals, and the like, may be provided. The user may then select a “Vacation” option, and the EIS software application 20 may then guide the user through a simple GUI that allowed the viewers to make a vacation package purchase with select hotels, and the like.

In another application example, the end user may hear a song that triggered an emotion such that the user is compelled to purchase the song. The EIS software application 20 enables the user to pause the show with the remote control unit 22 so as to select the on-screen menu button, and to navigate to “Current Music.” The user may then select the song of interest and plays back the selection. If the song is a desired commodity, the user may download the single song to satisfy an immediate need, and may then purchase the entire album, which can be shipped to the user. The user may further be able to access other information related to the song such as: album, artist, producer, inspiration, and the like.

In yet another application example, an end-user sees a pair of automobiles desirable for adding to an existing automobile collection. The user has an interest in purchasing the cars seen in the programming on the screen of the television 12. Immediately, he pauses the movie and gets into the “Current Screen” menu. Using a wireless keyboard or the remote control unit 22, to the user scrolls through the menu of available items and finds the automobile of interest. The user also obtains valuable information about collectable cars. The user may also be informed as to whether the automobile is available for sale and, if so, what the asking price may be. The seller and potential user/buyer can communicate through the entertainment information system 10. The end-user and the owner can reach an agreement on price via an email proxy server. The transaction can then be concluded based on the agreement so agreed to.

Further information about which the EIS software application 20 can provide information include, for example: songs, movies, videos, characters, architecture designs, biographies, homes, cars, furniture, designer clothes, decorative items, collectibles, autographed collectables, video games, and the like. There are various pieces of information that can be provided about the various objects a user can select. This information can include producers, manufacturer, sponsors, interior and exterior decorators, designers, architects, engineers, actors, decorators, services, manufactures, availabilities, contact information, cost, articles, videos, biographies, fact checks, and the like.

Upon receiving a purchase request by an end user, the entertainment information system 10 will filter the data of available items that were selected for purchase by the end user. This data is then classified by type (e.g., movie, song, cars, article of interest, vacation package, and the like) and the entertainment information system 10 will then send the list of requested purchases to pre-selected or preferred vendors who can satisfy the end user's list. If the preferred vendors are not able to satisfy all items on the list, secondary vendors may be sent the remaining items on the list. As a last resort, a researcher in the call center 42, for example, may manually search for the item on the list and email results to the end user's email address while the entertainment is still viewable on the screen of the television 12. End users will then make the final purchasing decisions.

It is to be understood that the description herein is only exemplary of the invention, and is intended to provide an overview for the understanding of the nature and character of the disclosed systems. The accompanying drawing is included to provide a further understanding of various features and embodiments of the method and devices of the invention which, together with their description serve to explain the principles and operation of the invention.

What is claimed is:

1. A system for enhancing television viewing, said system comprising:
a control unit including a software application for detecting programming being displayed on a television, said software application further providing a graphical user interface to enable a viewer to obtain information about a selected object of interest appearing in said programming being displayed by said television;
an inquiry server in communication with said control unit, said inquiry server configured to receive a viewer inquiry about said selected object of interest, and retrieve information about said selected object of interest in response to said viewer inquiry;
an information server in communication with said inquiry server, said information server having an Internet link to said selected object in said television display, said Internet link for enabling said inquiry server to obtain information related to said selected object of interest and provide said obtained information to said inquiry server; and
a purchasing server configured to transmit a purchase request to an object provider, said purchasing server configured to receive said purchase inquiry from said inquiry server, and communicate with a viewer account for sending a purchase request confirmation to said viewer.

2. The system of claim 1, wherein-said-control unit is configured to allow the viewer to pause the programming being viewed.

3. The system of claim 1, wherein said control unit comprises a software application written in one or more computer codes and stored on computer readable media, said software application having code segments to provide said graphical user interface.

4. The system of claim 1, wherein said object of interest is selected from the group consisting of songs, movies, videos, characters, architecture designs, biographies, homes, cars, furniture, designer clothes, decorative items, collectibles, autographed collectables, and video games.

5. The system of claim 1, wherein said obtained information is selected from the group consisting of decorators, designers, architects, engineers, actors, decorators, services, manufactures, availabilities, contact information, cost, articles, videos, biographies, and fact checks.

6. The system of claim 1, wherein said information server is updated for new programming.

7. An entertainment information system for enhancing television viewing, said system comprising:
a software application for identifying the title and the time track of entertainment displayed on the television;
said software application including software written in one or more computer codes and stored on computer readable media in said entertainment information system, said software having code segments to display a graphical user interface on the television, said code segments for enabling a viewer to select an object of interest displayed on the television so as to request information via the Internet about said selected object of interest;
an information server in communication with said software application, said information server configured to provide said requested information to the viewer based on said identification of said detected title and time track of said entertainment displayed on the television;
an information server in communication with said inquiry server, said information server configured to provide to said inquiry server a link to a vendor of said selected object of interest in response to receiving said requested information; and
a purchasing server configured to receive a viewer purchasing request from said information server and for distributing said viewer purchasing request to at least one provider for either purchase or fulfillment.

8. The entertainment information system of claim 7, wherein the object of interest is selected from the group consisting of songs, movies, videos, characters, architecture designs, biographies, homes, cars, furniture, designer clothes, decorative items, collectibles, autographed collectables, and video games.

9. The entertainment information system of claim 7, wherein the requested information is selected from the group consisting of decorators, designers, architects, engineers, actors, decorators, services, manufactures, availabilities, contact information, cost, articles, videos, biographies, and fact checks.

10. The entertainment information system of claim 7, wherein said inquiry server comprises a database including audio visual file titles, audio visual file time stamps, and related content communication links to independent site servers for said entertainment being displayed on the television.

11. The entertainment information system of claim 7, wherein said software application functions to detect the titles of audio visual files being viewed on the television, said application further referencing stored data packet data packet time stamps to a time track associated with said audio visual file being viewed on the television.

12. The entertainment information system of claim 7, wherein said graphical user interface appears on said display in response to an action by the television viewer.

13. A video player software application functioning to perform an action comprising the steps of:
playing on a display screen an audio visual program from one of an open source video and a closed source video on a digital platform and apparatus;
detecting the video title of said audio visual program;
time tracking said audio visual program during viewing; and
providing a graphical user interface on said viewing screen related to an Internet website that contains content related to said audio video program playing on said display screen.

14. The video player software application of claim 13 wherein said video player application enables the viewer to select a video files from a video streaming service or website.

15. The video player software application of claim 13, wherein said software application further functions to make website links available to the viewer based on preset time intervals as a function of audio visual time lines.

16. The video player software application of claim 13, wherein said software application functions to identify an audio visual file name from a received audio visual feed and to follow an audio visual time track.

17. The video player software application of claim 13, wherein said software application functions to identify an audio visual file based on audio in said audio visual file.

18. The video player software application of claim 13, wherein independent website links are made available dependent on contents seen or sounds heard in said audio visual file.

19. The video player software application of claim 13, wherein the viewer is enabled to save Internet links a folder.

20. The video player software application of claim 19, wherein the user is enabled to share the contents of said folder via social media.
